(19) United States
(12) Patent Application Publication
(10) Pub. No.: US 2020/0011058 A1
(43) Pub. Date: Jan. 9, 2020

(54) STRUCTURAL STEEL SUPPORTING MEMBER

(71) Applicant: JING-XIN SOLAR LTD., TAINAN CITY (TW)

(72) Inventor: CHING-LUNG YANG, TAINAN CITY (TW)

(21) Appl. No.: 16/455,089

(22) Filed: Jun. 27, 2019

(30) Foreign Application Priority Data
Jul. 3, 2018 (TW) 107208996

(51) Int. Cl. E04C 3/32; H02S 20/00

(52) U.S. Cl. CPC E04C 3/32; H02S 20/00

(57) ABSTRACT

A structural steel supporting member includes a vertical post and two opposing vertical plates. The two vertical plates are integrally connected to the top end of the vertical post and are spaced apart by a predetermined distance such that a positioning groove is formed between the top end of the vertical post and the inner sides of the two vertical plates. Thanks to the positioning groove, a structural steel beam that is used to support a solar panel module can be rapidly positioned and installed without using some of the conventionally required components, and the tilt angle of the structural steel beam can be adjusted as needed.

### BACKGROUND OF THE INVENTION

### 1. Field of the Invention

The present invention relates to solar panels and more particularly to a supporting member configured to support a structural steel member that carries a solar panel module.

### 2. Description of the Related Art

A solar power generation system works mainly by absorbing solar energy into solar panels, converting the absorbed solar energy into electric energy, and storing the electric energy for later use. As the solar panels of a solar power generation system occupy a lot of space, it is common practice nowadays to install solar panels on the roof of a building, on an outdoor plot of land, or along the roadside to make the most of available space. While installing a solar panel, a large number of components are generally required to fasten the steel members (e.g., a combination of steel beams and steel columns) that are used to support the solar panel. These components, however, add to the difficulty of not only positioning and assembly but also the adjustment of the tilt angle of the solar panel, causing inconvenience in subsequent use.

### SUMMARY OF THE INVENTION

The primary objective of the present invention is to provide a structural steel supporting member that allows a structural steel beam to be positioned and installed rapidly and to have its tilt angle adjusted with ease.

To achieve the above objective, the present invention provides a structural steel supporting member that includes a vertical post and two opposing vertical plates. The two vertical plates are integrally connected to the top end of the vertical post and are spaced apart by a predetermined distance such that a positioning groove is formed between the top end of the vertical post and the inner sides of the two vertical plates. The positioning groove makes it easier to position and install a structural steel beam that is used to support a solar panel module, and this is why the structural steel supporting member of the present invention can dispense with some of the components that are conventionally required to position and install such a structural steel beam. The positioning groove also allows the tilt angle of the structural steel beam, and hence of the solar panel module supported thereby, to be adjusted conveniently.

Preferably, the vertical post is a solid cylindrical body, and the distance between the two vertical plates is smaller than the diameter of the vertical post. More specifically, the top end of the vertical post has two opposing tapered portions, and each of the two vertical plates is integrally connected to one of the tapered portions of the vertical post.

Preferably, each vertical plate has a slot that allows the position of the structural steel beam to be finetuned, and the major-axis direction of each slot is perpendicular to the axial direction of the vertical post.

Preferably, the positioning groove is provided therein with a reinforcing plate, and the reinforcing plate is fixed on one of the vertical plates to increase the overall structural strength of the structural steel supporting member. Preferably, the reinforcing plate has a positioning portion at each of its top edge and bottom edge, and the two positioning portions are intended to abut against the top and bottom sides of the structural steel beam respectively to better position the structural steel beam.

The structural details, technical features, assembly method, and use of the structural steel supporting member of the present invention will be described at greater length below. However, as a person of ordinary skill in the art would understand, the following detailed description and the specific embodiments disclosed therein serve illustrative purposes only and are not intended to be restrictive of the scope of the invention.

### BRIEF DESCRIPTION OF THE DRAWINGS

FIG. 1 is a perspective view of the structural steel supporting member according to the first embodiment of the present invention;

FIG. 2 is a side view of the structural steel supporting member according to the first embodiment of the invention;

FIG. 3 is a partially exploded perspective view showing the structural steel supporting member according to the first embodiment of the invention in use with a structural steel beam;

FIG. 4 is an assembled perspective view of the structural steel supporting member and structural steel beam in FIG. 3;

FIG. 5 is an exploded perspective view showing the structural steel supporting member according to the second embodiment of the invention in use with a structural steel beam; and

FIG. 6 is an assembled perspective view of the structural steel supporting member and structural steel beam in FIG. 5.

### DETAILED DESCRIPTION OF THE INVENTION

To begin with, the applicant wishes to point out that identical or similar elements or structural features in the following embodiments and the accompanying drawings are indicated by the same reference numeral.

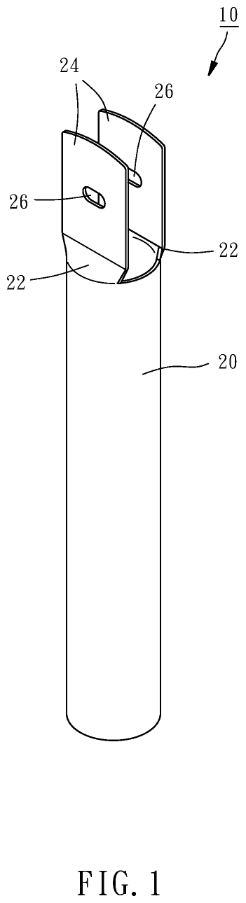

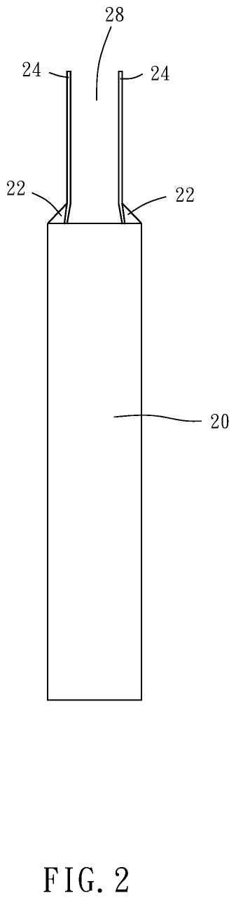

Referring to FIG. 1 and FIG. 2, the structural steel supporting member 10 according to the first embodiment of the present invention includes a vertical post 20 and two vertical plates 24.

The vertical post 20 in this embodiment is a solid cylindrical body. The top end of the vertical post 20 has two opposing tapered portions 22. The bottom end of the vertical post 20 is configured to be fixed on the roof of a building or on the ground.

Each of the two vertical plates 24 is integrally connected to the top end of one of the tapered portions 22 of the vertical post 20. The two vertical plates 24 are spaced apart by a predetermined distance such that a positioning groove 28 is formed between the inner sides of the two vertical plates 24 and the top end of the vertical post 20. The distance between the two vertical plates 24 is smaller than the diameter of the vertical post 20. Each vertical plate 24 has a slot 26, whose major axis extends in a direction perpendicular to the axial direction of the vertical post 20.

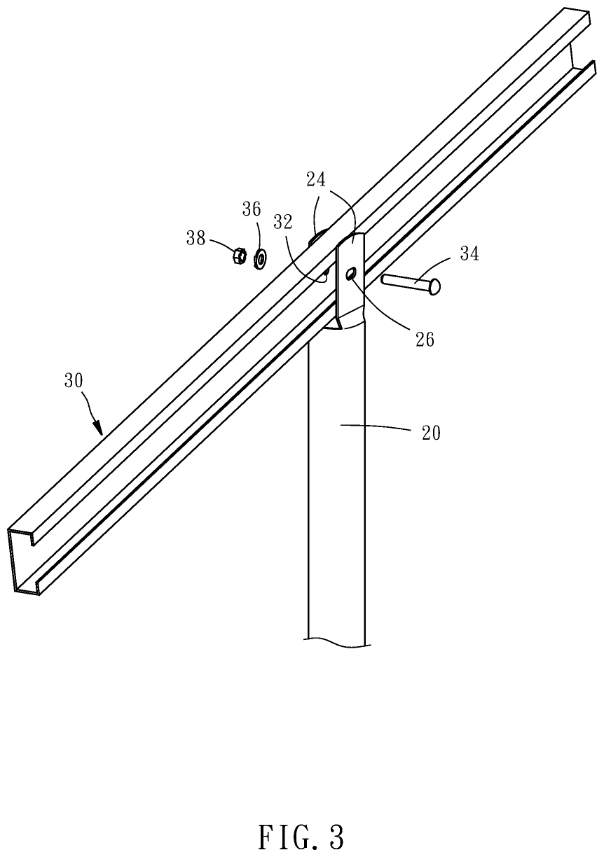

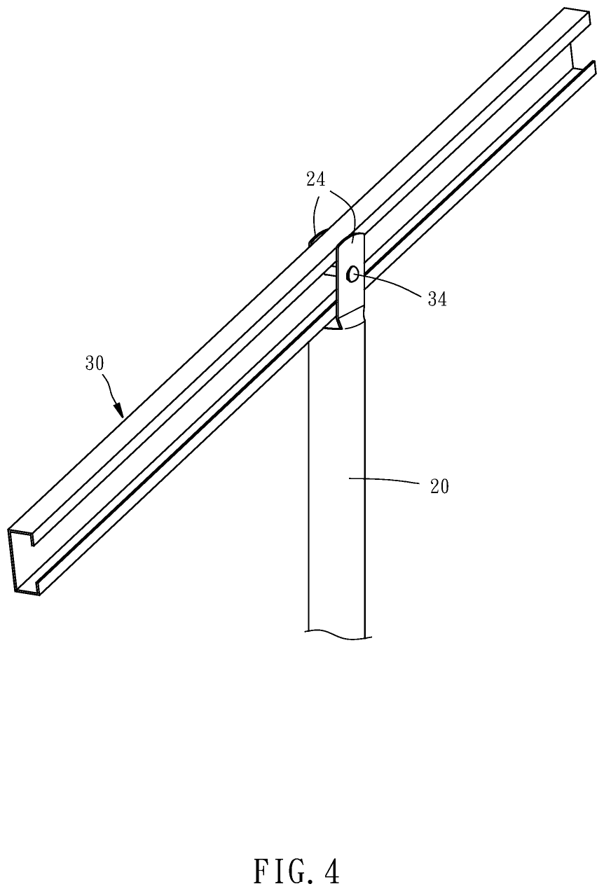

To use, referring to FIG. 3 and FIG. 4, a structural steel beam 30 is placed into the positioning groove 28, with a solar panel module (not shown) fixed on the top side of the structural steel beam 30, the bottom side of the structural steel beam 30 lying on the top end of the vertical post 20, and the two opposite lateral sides of the structural steel beam 30 restricted by the two vertical plates 24 respectively. Then, a bolt 34 is passed through the slot 26 of one of the two vertical plates 24, a through hole 32 in the structural steel beam 30, and a washer 36, before being locked with a nut 38 to complete the positioning and installation of the structural steel beam 30. The nut 38 can be subsequently loosened so that not only can the position of the structural steel beam 30 be finetuned within the range defined by the slots 26, but also the tilt angle of the structural steel beam 30 can be adjusted. Once the desired position and angle are reached, the nut 38 is tightened again to fix the entire assembly at that position and angle.

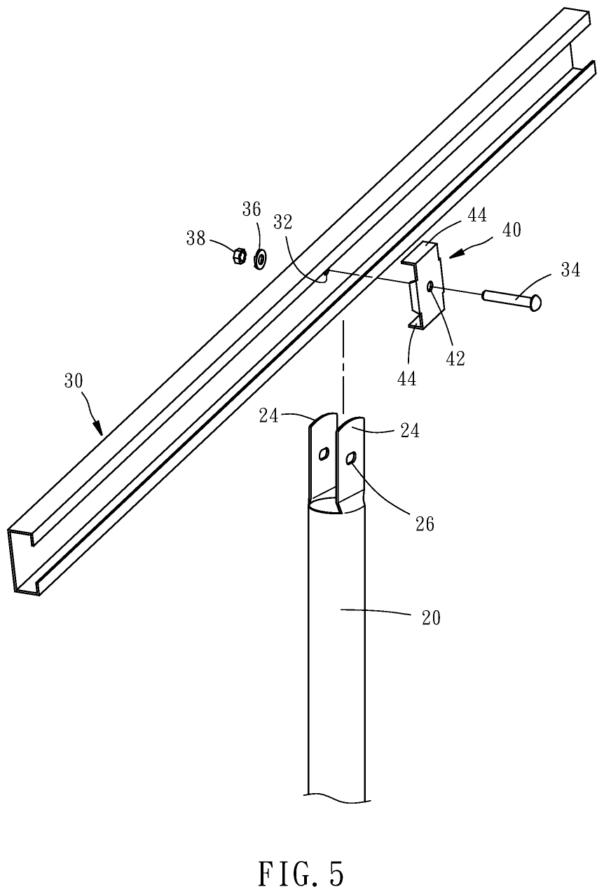

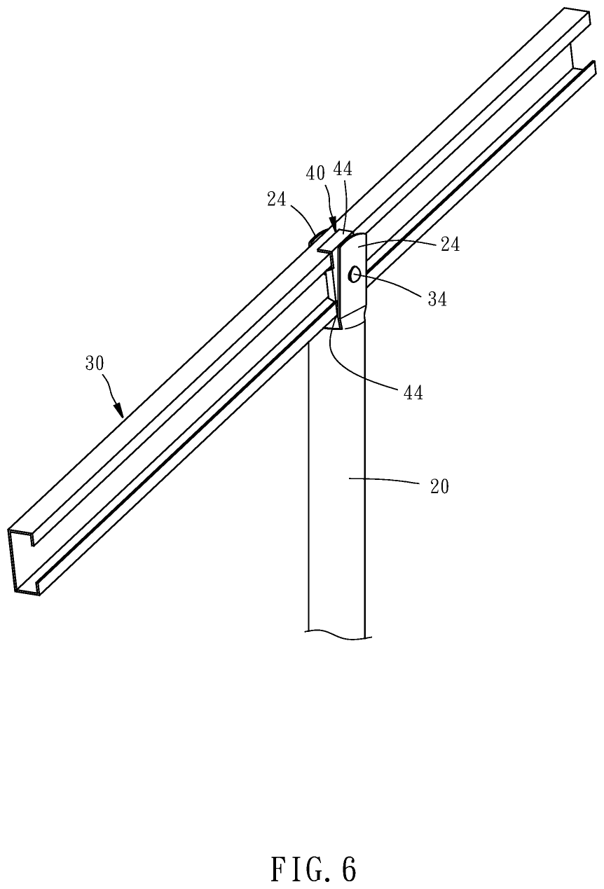

FIG. 5 and FIG. 6 show the second embodiment of the present invention, wherein a reinforcing plate 40 is additionally provided to increase the overall structural strength of the structural steel supporting member. The reinforcing plate 40 is provided in the positioning groove 28 and has a fixing hole 42 to be penetrated by the bolt 34 so that the reinforcing plate 40 is fixed on one of the vertical plates 24. The top and bottom edges of the reinforcing plate 40 are each provided with a positioning portion 44. The two positioning portions 44 are designed to abut against the top and bottom sides of the structural steel beam 30 respectively so as to position the structural steel beam 30 more securely.

According to the above, the structural steel supporting member 10 disclosed herein has a grooved structure formed by the vertical post 20 and the two vertical plates 24 to allow rapid positioning and installation of the structural steel beam 30 without using some of the components conventionally required for the same purpose. This makes it easier to fasten the entire assembly together. Moreover, the tilt angle of the structural steel beam 30, and hence the angle of the solar panel module mounted on the structural steel beam 30, can be adjusted as needed at the same time.

1. A structural steel supporting member, comprising:
a vertical post; and
two opposing vertical plates integrally connected to a top end of the vertical post and spaced apart by a predetermined distance such that a positioning groove is formed between inner sides of the two vertical plates and the top end of the vertical post.

2. The structural steel supporting member of claim 1, wherein the vertical post is a solid cylindrical body, and the predetermined distance between the two vertical plates is smaller than a diameter of the vertical post.

3. The structural steel supporting member of claim 2, wherein the top end of the vertical post has two opposing tapered portions, and each of the two vertical plates is integrally connected to one of the tapered portions.

4. The structural steel supporting member of claim 1, wherein each of the vertical plates has a slot, and each said slot has a major-axis direction perpendicular to an axial direction of the vertical post.

5. The structural steel supporting member of claim 1, further comprising a reinforcing plate, wherein the reinforcing plate is provided in the positioning groove and is fixed on one of the vertical plates.

6. The structural steel supporting member of claim 5, wherein the reinforcing plate has a top edge and a bottom edge each provided with a positioning portion.
